(19) United States
(12) Patent Application Publication
(10) Pub. No.: US 2003/0183537 A1
(43) Pub. Date: Oct. 2, 2003

(54) Method of spatial monitoring and controlling corrosion of superheater and reheater tubes

(76) Inventors: David Eden, Spring, TX (US); Bernard P. Breen, Pittsburgh, PA (US); James E. Gabrielson, Hanover, MN (US); Robert Schrecengost, Beaver, PA (US); Mark Valvano, Ellwood City, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/114,560

(22) Filed: Apr. 2, 2002

(51) Int. Cl. G01N 27/26

(52) U.S. Cl. 205/775.5; 204/404

(57) ABSTRACT

A method for monitoring and reducing corrosion in superheater and reheater furnace tubes measures electrochemical activity associated with corrosion mechanisms while corrosion is occurring at the surface of the tubes as they are exposed to combustion products. A sensor containing two electrodes spaced apart by an insulator is used. The surface of a boiler tube is one of the electrodes. The sensor is connected to a corrosion monitor. The monitor contains a computer and software, which determines a corrosion rate from the measured electrochemical activity. That rate is compared to a standard to determine if the rate is within acceptable limits. If not, the furnace operator of the furnace or an Adaptive Process Controller (APC) adjusts one or more burners to change the combustion products that are responsible for the corrosion.

### FIELD OF INVENTION

The invention relates to a method for determining a rate at which superheater and reheater tubes that are exposed to combustion products are corroding and taking steps to reduce the corrosion rate.

### BACKGROUND OF THE INVENTION

For many years electricity has been produced using boilers or furnaces which generate steam that drives a turbine. Many of the furnaces used to produce electricity have groups of tubes near the furnace exit through which steam flows. The steam is heated by convective heat transfer. These tubes are suspended in the gas flow. The tubes are usually made from iron containing metal alloys often containing 1-5% chromium. During operation of the furnace an iron oxide film forms on the fire side surface of the tubes. Ash particles and slag also accumulate on top of the iron oxide film. That slag can be a solution or mixture of iron and silicon oxides, which is commonly identified as FeₓO_{y}SiO₂. Other chemicals, particularly calcium may also be present in the slag. Depending upon the relative amounts of calcium, iron and silicon present in the slag, and also the presence of potassium and/or phosphate aluminates, the slag will be either liquid or solid at operating temperatures within the furnace. When the ash is liquid, it is generally referred to as fused ash, vitrified ash, or most commonly as slag.

Another type of slag can also form in a furnace when a corrosive mixture of alkali iron sulfates ((Na,K)₃Fe(SO₄)₃) forms on the superheater and reheater tubes. When this mixture melts the corrosion can be severe.

Other superheater slags form from sodium, vanadium and oxygen. Usually these sodium vanadates have lower melting temperatures when the flue gas oxygen is higher. The vanadium is usually associated with residual oil. This type of slag often occurs when fuel oil is burned and is also corrosive.

Until recent years superheater and reheater tubes corroded slowly and had a service life of many years. However, the introduction of low NOx burners has increased the rate of corrosion of these tubes, which can reduce their life expectancy. The result is that not only do tubes have to be replaced, but the corrosion problem has also resulted in the need to improve coal quality, sometimes doubling the cost of coal. Also to circumvent vanadium corrosion it is sometimes necessary to buy more expensive fuel oil. Consequently, there is a need for a method that will reduce corrosion of superheater and reheater tubes in boilers fired to low NOx emissions.

The steam inside steam tubes is at a high pressure, typically from 600 to about 3500 psi. Consequently, the tubes could fail if their walls become too thin as a result of corrosion. For this reason, the industry has periodically measured the thickness of the walls of its tubes using sonic measuring techniques and other methods. When these measurements indicate that the walls are becoming too thin, the superheater tubes are replaced. While the industry has been able to determine corrosion rates from periodic measurements of wall thickness, corrosion rates determined in this way are of little use in efforts to control corrosion. That is so because the measurement intervals are such that significant corrosion has occurred between measurements. Furthermore, because several different furnace conditions likely occurred between measurements it is difficult or impossible to identify the condition that was responsible for the increased corrosion.

The corrosion of superheater and reheater tubes involves several mechanisms. First, removal of the protective oxide film allows further oxidation. Second, if the oxide film is not present the iron surface is attacked and pitted by condensed phase chlorides, which may be present. A third mechanism occurs when wet slag runs across the surface of the oxide film. As that happens, iron from the tube goes into the slag solution which contains low fusion calcium-iron-silicate eutectics, alkali iron trisulfates, or sodium vanadates that have formed in the liquid slag. Reduced sulfur in the form of S, H₂S, FeS or FeS₂ can react with the oxygen of the tube scale depriving the tube metal of its protective layer. Vanadium has different valence states that allow liquid sodium vanadate to react with oxygen from the gas. That reaction raises the vanadium oxidation state. Oxygen is deposited on the iron forming rust (FeO, Fe₂O₃, Fe₃O₄) and reducing the vanadium oxidation state. If one understood what caused each of the mechanisms to occur and could detect when they are occurring, then steps could be taken to prevent corrosion. Yet, prior to the present invention the art has not done this.

Within the past fifteen years corrosion engineers have developed probes and methods that can monitor corrosion rates in real time as corrosion is occurring in a variety of equipment. These probes and methods are based upon recognition that corrosion is an electrochemical process during which electrochemical activity is generated. Electrochemical noise is a generic term used to describe low amplitude, low frequency random fluctuations of current and potential observed in electrochemical systems. Thus, by placing electrodes in the corrosive environment, one can measure the electrochemical noise that is present. Hladky in U.S. Pat. No. 4,575,678 discloses that measurements of electrochemical noise in corrosive environments can be used to calculate a rate at which corrosion is occurring. He further discloses an apparatus for measuring corrosion that is occurring in a variety of liquid containing apparatus such as pipes, storage tanks, heat exchangers, pumps and valves. Eden et al. disclose a corrosion monitoring apparatus in U.S. Pat. No. 5,139,627 that also relies upon measurements of electrochemical noise. This apparatus has been commercialized by InterCorr International of Houston, Tex., and is being sold under the name SmartCET system. These devices have been used to measure corrosion in storage tanks and pipes. In those environments there is typically one type of corrosion occurring and temperatures seldom exceed a few hundred degrees. Prior to the present invention the art has not realized that electrochemical noise measuring devices could be used in furnaces where temperatures exceed 2000° F. and where corrosion occurs because of several mechanisms that could be occurring simultaneously, such as chloride reactions and metal oxidation, sulfation, and reduction reactions occurring within the wet slag of a coal fired or oil fired furnace.

### SUMMARY OF THE INVENTION

We provide a method for monitoring corrosion of superheater and reheater tubes by measuring electrochemical noise occurring at the surface of the tubes while that surface is exposed to combustion products. We further provide a method for controlling that corrosion. A probe or device which is affixed to at least one of the superheater or reheater tubes is provided for measuring electrochemical activity. The probe is connected to a corrosion monitor having a computer and software, which determines a corrosion rate from the measured electrochemical activity. That rate is compared to a standard to determine if the rate is within acceptable limits. If not, the operator of the furnace is notified and changes are made to the amount of air or fuel being provided to one or more burners.

Other objects and advantages of the invention will become apparent from a description of certain preferred embodiments shown in the drawings.

### BRIEF DESCRIPTION OF THE FIGURES

FIG. 1 is a perspective view of a first preferred embodiment of a corrosion sensor affixed to a superheater tube.

FIG. 2 is a sectional view taken along the line II-II of FIG. 1.

FIG. 3 is a perspective view of a second preferred embodiment of a corrosion sensor affixed to a superheater tube.

FIG. 4 is a sectional view taken along the line IV-IV of FIG. 3

FIG. 5 is a sectional view similar to FIGS. 2 and 4 of a third preferred embodiment of the sensor attached to two superheater tubes.

FIG. 6 is a sectional view similar to FIG. 5 of a fourth preferred embodiment of the sensor attached to two reheater tubes.

FIG. 7 is a perspective view of a fifth preferred embodiment of a corrosion sensor affixed to a superheater tube in which the sensor in which it is part of a probe.

FIG. 8 is a sectional view taken along the line VIII-VIII of FIG. 7.

### DESCRIPTION OF THE PREFERRED EMBODIMENTS

As shown in FIGS. 1 and 2, a thin metal band 1 is placed around a superheater tube 2. The metal band is preferably made of the same metal as the tube. The band is electrically separated from the tube, yet held to the tube by refractory cement 3. The thin band may also be tightened against the refractory by a self-tightening mechanism (not shown). During operation of the furnace slag forms on the fire side of the tube, i.e. the surface of the tube that is facing toward the burners. When the slag melts a pool of liquid 5 may form a conduction path from the tube to the band. The tube 2 and band 1 function as two spaced apart electrodes. Electrical leads 7 run from the metal band 1 and the tube 2 to a monitoring device 16.

The outside of the tube is exposed to the products of combustion since combustion is occurring within the furnace) Consequently, the outside surface of the tube is confronted by hot gases formed by combustion and slightly cooled by the furnace wall tubes. Steam flows through the center 6 of the tube 2. The tube 2 is heated by the hot products of combustion flowing past it and in turn heats the steam. During manufacture of the superheater tube panels an oxide layer is formed on the exposed surfaces of the tube. This oxide layer is present when the tube is installed in the furnace and provides some corrosion protection. During operation of the steam generator a slag layer is formed on most of the superheater and reheater tubes. Thus, the outside surface of the tube is coated with a slag that forms on the oxide film. At any given temperature in the furnace the slag will be liquid or solid depending upon the relative amounts of iron, calcium, silicon and other elements in the slag. It is also true that reducing conditions within the boiler can lower the fusion temperature of iron-calcium-silicon slag by 150° F. to as much as 300° F., i.e., from 2,300° F. down to 2,150° F. or even 2,000° F. Such reducing conditions are often created when burners are operated in a low NOx firing mode or when low NOx burners are used. Consequently, the slag will become liquid at much lower temperatures. When slag is in a liquid form iron from the boiler tubes easily migrates into the slag resulting in corrosion. Although the final liquid phase of the slag may not be electrochemical, the dissolving and migration of iron into that phase are electrochemical. Thus, the formation of liquid slag gives off electrochemical signals and noise, which can be detected through the electrical leads 7. Since corrosion is likely to occur while the slag is in a liquid phase, detection of phase change from solid to liquid is an indicator that corrosion has begun. The migration of iron atoms into the slag solution creates the electrical noise, which is a direct measure of the corrosion rate.

A second type of corrosion occurs when the protective oxide layer is removed. This can occur when a reducing atmosphere is present and flame impinges on the surface. This condition can exist during low NOx firing. Removal of the protective oxide film involves a reduction of iron oxide to reduced iron, or iron sulfide. That process is accompanied by generation of electrochemical activity. Such activity can also be detected.

During transition from oxide to reducing skin condition, the iron surface is attacked and pitted by the presence of condensed phase chlorides. These chlorides only attack the iron surface when it is in transition between oxidizing and reducing. The chloride and iron reaction is part of an electrochemical corrosion mechanism, which can be detected.

Corrosion also occurs on superheater and reheater tubes by the action of alkali iron trisulfate. Some mixtures of potassium and sodium iron trisulfates have melting points as low as 794 K. The fusion temperature of this eutectic is not much changed by reducing conditions. Also, in oil fired boilers superheater and reheater tubes can be corroded by sodium vanadate. Here lowering the excess air increases the fusion temperature.

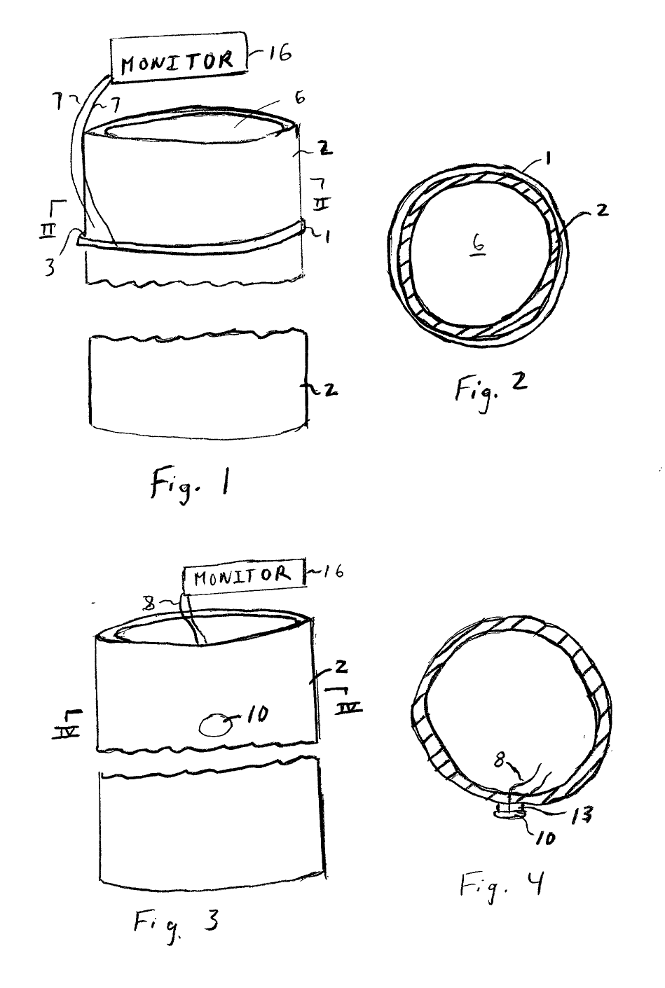

Since the corrosion mechanisms that occur on furnace boiler tubes are accompanied by electrochemical activity, we provide a sensor to detect the electrochemical activity that indicates corrosion is occurring. In the embodiment of FIGS. 1 and 2 the sensor is formed by the metal band 1 and leads 7 from the metal band and from the tube surface. The surface of the tube 2 and the metal band 1 cemented to the tube by cement 3 function as two spaced apart electrodes separated by an electrical insulator. As shown in FIG. 1, the connections to the electrodes can be leads 7 which extend through the flue gas to the exterior of the boiler. In alternative embodiment shown in FIGS. 3 and 4 we use a metal coupon 10 attached to the tube 2 by refractory cement 13 and leads 8 which are interior to the steam tube. The electrodes are connected to a corrosion monitor 16, which is external to the steam generator. The monitor 16 converts electrochemical activity detected by the electrodes into a corrosion rate. The technique is described in U.S. Pat. Nos. 4,575,678 to Hladkey and 5,139.627 to Eden et al. A corrosion monitor available from InterCorr International and under the name SmartCET could be used.

Another sensor that could be used is shown in FIG. 5. The sensor is fabricated in the same manner as the embodiments shown in FIGS. 1 through 4. In the embodiment of FIG. 5, the band electrode 1 is separated from the tube electrode 2 by the electrically insulating refractory 3 The band is electrically connected to an adjacent tube 9 by an extension of the band 19. The tubes 2 and 9 become the primary leads. The tubes are connected to the monitor 16 by low temperature leads 17 attached to the external surface of the tubes at a location that may be external to the boiler.

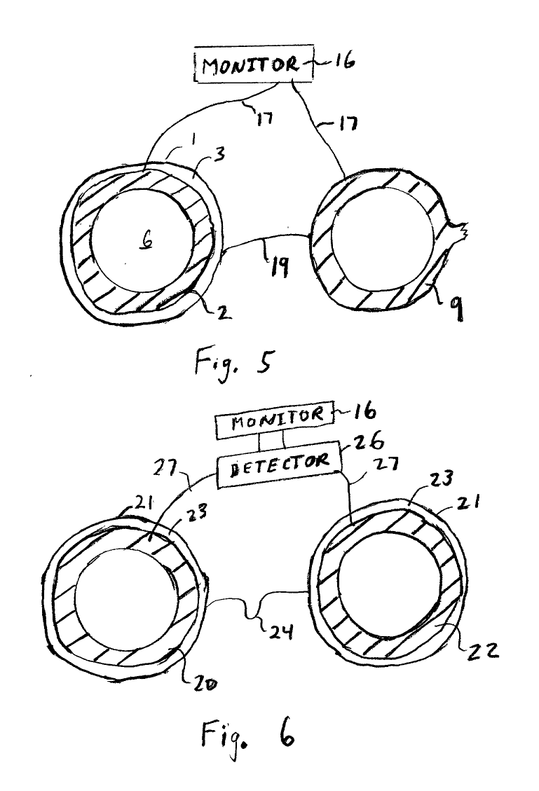

In another preferred embodiment shown in FIG. 6 the sensor is fabricated as part of two reheater tubes 20 and 22. This time the band 21 circles both tubes. The connection 24 between the two loops of the band needs only to be an electrical connection, which is robust enough to withstand the boiler environment. The connector 24 is shown bent to allow for relative movement of the tubes 20 and 22. In this case the two tubes 20 and 22 can be the primary leads to the outside of the steam generator. There they are connected to the monitor 16 by secondary leads 27. Alternatively a lead could be connected to each of the tubes 20 and 22 at the location of the band and these leads could be connected to the corrosion monitor. The insulating refractory 23 prevents current flow between the band or ring 21 and the tubes 20 and 22. The wires 27 connected from tubes 20 and 22 and a detector 26 capable of measuring current, i. The detector could be a simple voltage meter. When slag forms on the surface of the tubes, the slag can conduct electricity. Consequently, any electrochemical activity in the slag will generate detectable current flowing through tubes 20 and 22. The detector 26 is connected to a corrosion monitor 6. The corrosion monitor translates the detected current to measurements of corrosion occurring on the surface of the tube.

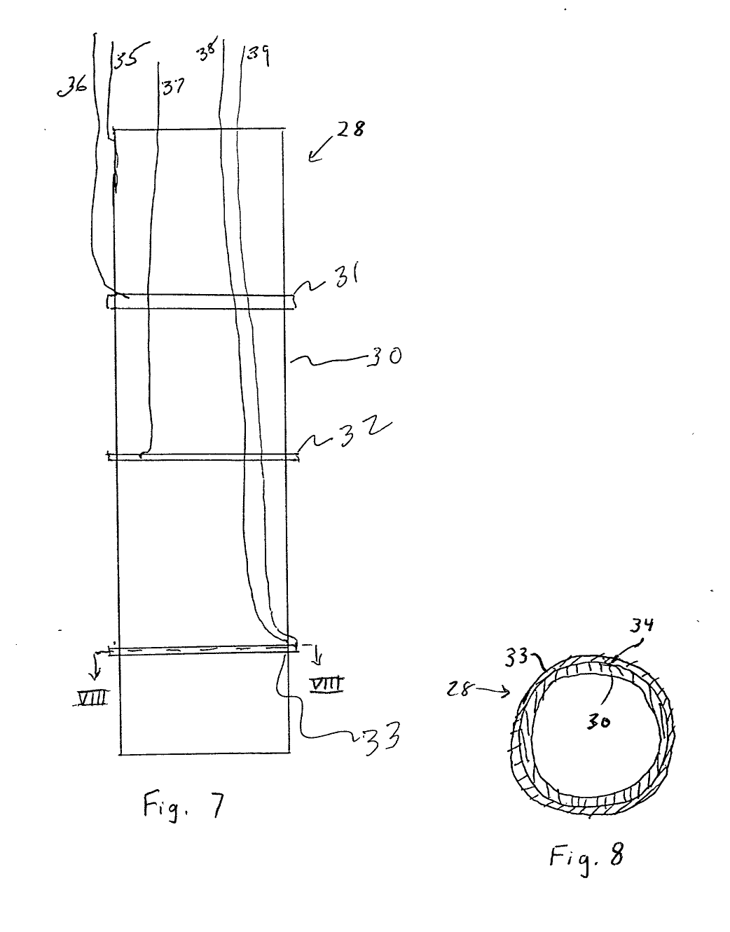

In another preferred embodiment shown in FIGS. 7 and 8 a probe 28 is fabricated, which is independent of the tubes. This probe is placed into the furnace adjacent to the fireside surface of at least one furnace tube. In the embodiment shown in FIGS. 7 and 8 we provide three, spaced-apart bands 31, 32, 33 encircling a cylindrical body 30. The bands are separated from the main body of the probe by insulating refractory 34 and form three separate sensors. When molten slag forms on the probe conductive paths are formed between the probe body 30 and one or more of bands 31, 32, or 33. The electrical signals between the band 31 and probe body 30 are conducted to a monitor (not shown) through the metal body 30 of the probe 28 to lead 35 which is external to the furnace and by lead 36 from band 31. The signal between band 32 and the probe is conducted by the probe body 30 to lead 35 and by lead 37 which passes through the inside of the probe to the exterior of the steam generator. The signals between band 33 and probe body 30 pass through leads 38 and 39, both of which are internal to probe 30. This probe will be cooled by a flow of air or steam that may be vented into the furnace or boiler.

The corrosion monitor in all of the embodiments shown in the drawings provide the furnace operator with real time information about when corrosion is occurring. That information can be correlated to several operating conditions such as burner air register settings, slot register settings, fan settings, fuel consumption and other factors. We have observed that corrosion rates are often higher when reducing conditions exist in the furnace. One can change these conditions by changing the air flow into the furnace. By correlating burner air register or slot air register settings (when available) with corrosion rate data, a profile can be used to identify operating conditions of individual burners which are conducive to increased corrosion rates. Then, these operating conditions can be avoided. Even if no profile exists or can be developed, information on corrosion rates is still useful. The operator can compare the detected corrosion rate to a tube life standard.

Tubes are considered to be exhausted when the thickness of the tube wall reaches a specific thickness. That may be different for tubes of different alloy compositions. Nevertheless, it is a simple matter to establish an acceptable corrosion rate for a given tube by dividing the difference between the initial tube wall thickness and the minimum acceptable tube wall thickness by the desired tube life in years. If the observed corrosion rate is greater than the acceptable corrosion rate, the furnace operator can change the burner settings to reduce the corrosion rate even when protective or sacrificial cladding is used.

It should be noted that changing burner settings could change the amount of NOx, SOx and particulates exiting the combustion chamber. Consequently, the furnace operator or adaptive control software (sometimes called an Adaptive Process Controller or APC) which controls the furnace should also look at the monitors which measure these emissions or conduct emission tests after changing the burner settings. For a particular furnace, it may be necessary to induce a higher than desirable corrosion rate of the furnace boiler tubes to meet desired emission levels. Thus, in one embodiment of our method the furnace operator or APC monitors corrosion rates, compares each observed rate to a standard, checks emission levels, adjusts at least one burner and then checks emission levels again. The second emissions check may prompt the operator or APC to make further burner adjustments to reduce emissions. That adjustment could change corrosion rates, but will determine the most effective NOx control operating conditions. Steam generators typically have more than one burner. Consequently, several burners could be adjusted in response to an observed corrosion rate.

Although we have illustrated a single probe, we expect that furnace owners would install several such probes throughout the boiler tubes. If any of the embodiments of FIGS. 1 through 6 are used, sensors would likely be created on several tubes. This would be done because conditions within the furnace vary. A reducing atmosphere could be present in one region of the furnace, but not be present in other regions. Having several probes or sensors enables the furnace operator or APC to determine if a particular burner has a greater effect upon corrosion occurring at a particular superheater or reheater location. With that knowledge the operator or APC could adjust only that burner or operate that burner in a manner to reduce corrosion while generating more NOx emissions and at the same time adjust another burner to compensate for the increased NOx. Similarly, should an adjustment made to a burner to reduce corrosion result in increased NOx emissions, the furnace operator or APC may be able to adjust reburn injectors in the upper furnace to remove more NOx and SOx. This technique is well known in the art. Examples of such reburn methods are disclosed in U.S. Pat. Nos. 6,030,204; 5,746,144; 5,078,064 and 5,181,475.

We have here described certain present preferred embodiments of our method and monitor for monitoring and reducing corrosion of superheater and reheater tubes. However, it should be distinctly understood that our invention is not limited thereto, but may be variously embodied within the scope of the following claims.

We claim:

1. A method of controlling corrosion of boiler tubes wherein the boiler tubes have a fire side surface that is exposed to products of combustion that are deposited on the fire side surface and in which deposited products electrochemical activity is created when corrosion occurs at the fire side surface, the tubes being in a furnace having burners to which fuel and air are provided comprising:
a. providing on the fire side surface of a boiler tube a sensor capable of measuring electrochemical activity occurring in an electrochemical system, the sensor comprising a first electrode, a second electrode and an insulator between the two electrodes such that at least a portion of the fireside surface is the first electrode;
b. monitoring with the sensor electrochemical activity occurring at the fire side surface of the boiler tube; and
c. determining from the monitoring of the electrochemical activity a corrosion rate that is occurring at the fire side surface of the boiler tube.

2. The method of claim 1 wherein acceptability of the corrosion rate is determined and if the corrosion rate is not acceptable, further comprising adjusting at least one of the fuel and air that is being provided to at least one of the burners.

3. The method of claim 1 wherein the second electrode is a band encircling the boiler tube.

4. The method of claim 1 wherein the second electrode is a metal coupon.

5. The method of claim 1 wherein the electrochemical activity generates an electrical signal that passes through the boiler tube.

6. The method of claim 1 wherein the electrical signal passes through a second tube.

7. The method of claim 1 also comprising the steps of measuring NOx emissions from the furnace before and after adjusting at least one of the fuel and air that is being provided to at least one of the burners.

8. The method of claim 1 wherein the furnace contains at least one fuel injector in an upper portion of the furnace, also comprising the step of adjusting the at least one fuel injector in an upper portion of the furnace.

9. The method of claim 8 also comprising the step of measuring emissions of at least one of NOx, SOx and particulates after adjusting the at least one fuel injector.

10. The method of claim 1 also comprising the steps of measuring emissions of at least one of NOx, SOx and particulates after adjusting the burner and then again adjusting that burner.

11. The method of claim 1 also comprising:
a. adjusting one burner;
b. measuring at least one of NOx, SOx and particulates after the adjusting step; and
c. then adjusting at least one of the fuel and air that is being provided to a second burner.

12. The method of claim 1 wherein the at least one tube is selected from the group consisting of reheater tubes and superheater tubes.

13. A method of controlling corrosion of boiler tubes wherein the boiler tubes have a fire side surface that is exposed to products of combustion that are deposited on the fire side surface and in which deposited products electrochemical activity is created when corrosion occurs at the fire side surface, the tubes being in a furnace having burners to which fuel and air are provided comprising:
a. providing a probe adjacent the fire side surface of at least one tube, the probe capable of measuring electrochemical activity occurring in an electrochemical system;
b. monitoring with the probe electrochemical activity occurring at the fire side surface of the at least one tube; and
c. determining from the monitoring of the electrochemical activity a corrosion rate that is occurring at the fire side surface of the at least one tube.

14. A method of claim 13 wherein acceptability of the corrosion rate is determined and if the corrosion rate is not acceptable, further comprising adjusting at least one of the fuel and air that is being provided to at least one of the burners.

15. The method of claim 13 wherein the probe has multiple sensors.

16. The method of claim 13 wherein the probe is comprised of:
a. a metal tube;
b. a metal ring encircling and attached to the tube with a refractory material such that the refractory material electrically insulates the tube from the ring;
c. a first lead attached to the metal tube; and
d. a second lead attached to the ring.

17. The method of claim 16 wherein the probe also comprises:
a. a second metal ring encircling and attached to the tube with a refractory material such that the refractory material electrically insulates the tube from the ring; and
b. a third lead attached to the second metal ring.

18. The method of claim 17 wherein the probe also comprises:
a. a third metal ring encircling and attached to the tube with a refractory material such that the refractory material electrically insulates the tube from the third metal ring; and
b. a fourth lead attached to the third metal ring.

19. A probe for monitoring corrosion of slag covered metal surfaces comprising:
a. a metal pipe;
b. a metal ring encircling and attached to the tube with a refractory material such that the refractory material electrically insulates the tube from the ring;
c. a first lead attached to the metal tube; and
d. a second lead attached to the ring.

20. The probe of claim 19 also comprising:
a. a second metal ring encircling and attached to the tube with a refractory material such that the refractory material electrically insulates the tube from the ring; and
b. a third lead attached to the metal ring.

21. The probe of claim 20 also comprising:
a. a third metal ring encircling and attached to the tube with a refractory material such that the refractory material electrically insulates the tube from the third metal ring; and
b. a fourth lead attached to the third metal ring.
